(19) United States
(12) Patent Application Publication
(10) Pub. No.: US 2013/0342324 A1
(43) Pub. Date: Dec. 26, 2013

(54) METHOD, DEVICE AND SYSTEM FOR IDENTIFYING AND SENDING RADIO FREQUENCY SIGNAL

(71) Applicant: Huawei Technologies Co., Ltd., (US)

(72) Inventor: Guoping Liu, Shenzhen (CN)

(73) Assignee: Huawei Technologies Co., Ltd., Shenzhen (CN)

(21) Appl. No.: 13/673,599

(22) Filed: Nov. 9, 2012

(30) Foreign Application Priority Data
Feb. 24, 2012 (CN) 201210044514.8

(51) Int. Cl. G06K 7/10

(52) U.S. Cl. CPC G06K 7/10366
USPC 340/10.1

(57) ABSTRACT

Embodiments of the present invention provide a method, device and system for identifying and sending a radio frequency signal. The method for identifying a radio frequency identification label includes: sending a control signal to a radio frequency signal sending device, so that the radio frequency signal sending device sends a radio frequency signal according to the control signal, the radio frequency signal at least carrying identity identification information; and receiving the radio frequency signal sent by the radio frequency signal sending device, and acquiring the identity identification information in the radio frequency signal. The method for identifying the RFID label, and the method, device and system for sending the radio frequency signal provided in the embodiments of the present invention increase the identification effect on the RFID label.

### CROSS-REFERENCE TO RELATED APPLICATION

This application claims priority to Chinese Patent Application No. 201210044514.8, filed on Feb. 24, 2012, which is hereby incorporated by reference in its entirety.

### FIELD OF THE INVENTION

The present invention relates to radio frequency technologies, and in particular, to a method, device and system for identifying and sending a radio frequency signal.

### BACKGROUND OF THE INVENTION

With the ever-development of radio frequency technologies, radio frequency identification (RFID) has been widely applied in human production and life, such as a bus card, an access card, and a time card. The RFID is a non-contact automatic identification technology, which automatically identifies a target object and acquires related data through a radio frequency signal, and the identification work does not need any artificial interference.

An RFID system generally includes a reader and one or more labels. An RFID chip in a label stores related data information, the data information in the RFID chip is sent to the reader through an antenna, so that the reader performs identification on the label. The RFID is a radio technology, so that if multiple labels exist in the radio coverage of a reader, a certain label cannot be accurately located only through the reader. In the prior art, the coverage of a reader antenna is reduced to ensure that only one label exists in the coverage of the antenna, and the object of sequential reading is reached by reading different labels through switching different antennas in a given sequence. The location of the antenna is known, so the location of the label read by the antenna can be known. However, it is required to design an antenna for every label, the connection requirement between the antenna and the reader is high, the circuit design is complex, costs in the apparatus are high, and the antenna is not suitable to be mounted in many scenarios, for example, a metal shielded area.

### SUMMARY OF THE INVENTION

Embodiments of the present invention provide a method, device and system for identifying and sending a radio frequency signal, to improve an identification effect on an RFID label.

An embodiment of the present invention provides a method for identifying a radio frequency signal, where the method includes:

sending a control signal to a radio frequency signal sending device, so that the radio frequency signal sending device sends a radio frequency signal according to the control signal, the radio frequency signal at least carrying identity identification information; and

receiving the radio frequency signal sent by the radio frequency signal sending device, and acquiring the identity identification information in the radio frequency signal.

An embodiment of the present invention provides a method for sending a radio frequency signal, where the method includes:

receiving a control signal, the control signal being used to instruct a radio frequency identification (RFID) label to initiate a capability of sending a radio frequency signal, or being used to instruct the RFID label to send a radio frequency signal that can be identified by a reader; and

sending a radio frequency signal according to the control signal, the radio frequency signal at least carrying identity identification information.

An embodiment of the present invention provides a reader, where the reader includes a control module and an antenna module connected to the control module;

the control module is configured to: generate a control signal, and send the control signal to the antenna module; and receive a radio frequency signal from the antenna module, and acquire identity identification information in the radio frequency signal; and

the antenna module is configured to: send the control signal to a radio frequency signal sending device, so that the radio frequency signal sending device sends the radio frequency signal according to the control signal, the radio frequency signal at least carrying the identity identification information; and receive the radio frequency signal sent by the radio frequency signal sending device, and send the radio frequency signal to the control module.

An embodiment of the present invention provides a radio frequency identification (RFID) label, where the RFID label includes an antenna and an RFID chip connected to the antenna,

the antenna is configured to: receive a control signal, the control signal being used to instruct the radio frequency identification (RFID) label to initiate a capability of sending a radio frequency signal, or being used to instruct the RFID label to send a radio frequency signal that can be identified by a reader; receive a radio frequency signal sent by the RFID chip, and send the radio frequency signal to the reader; and

the RFID chip is configured to: initiate the capability of sending the radio frequency signal according to the control signal, or generate the radio frequency signal that can be identified by the reader, and send the radio frequency signal to the antenna, the radio frequency signal at least carrying identity identification information.

An embodiment of the present invention provides a radio frequency signal sending device, where the device includes a radio frequency identification (RFID) label and a controller,

the controller is configured to: receive a control signal, and initiate a capability of sending a radio frequency signal of the RFID label according to the control signal, or instruct the RFID label to send a radio frequency signal that can be identified by a reader according to the control signal; and

the RFID label is configured to: send the radio frequency signal according to the control of the controller, the radio frequency signal at least carrying identity identification information.

An embodiment of the present invention provides a radio frequency signal sending device, where the device includes a radio frequency identification (RFID) label, the RFID label is configured with a switch, the switch is opened or closed under control of a control signal, so as to control the RFID label to disable or initiate a capability of sending a radio frequency signal, or control the RFID label to send a radio frequency signal that can be identified by a reader.

An embodiment of the present invention provides a radio frequency identification system, the system includes at least one reader and multiple radio frequency identification (RFID) labels, where:

the reader is configured to: send a control signal to the RFID label, so that the RFID label sends a radio frequency signal according to the control signal; receive the radio frequency signal sent by the RFID label, and acquire identity identification information in the radio frequency signal; and

the RFID label is configured to: receive the control signal, the control signal being used to instruct the RFID label to initiate a capability of sending the radio frequency signal, or being used to instruct the RFID label to send a radio frequency signal that can be identified by the reader; and send the radio frequency signal according to the control signal, the radio frequency signal at least carrying the identity identification information.

An embodiment of the present invention provides a radio frequency identification system, the system includes at least one reader, multiple radio frequency identification (RFID) labels, and multiple controllers that correspond to the RFID labels respectively, where:

the reader is configured to: send a control signal to the controller, so that the controller controls a corresponding RFID label to send a radio frequency signal; receive the radio frequency signal sent by the RFID label, and acquire identity identification information in the radio frequency signal;

the controller is configured to: receive the control signal sent by the reader, and, according to the control signal, control the RFID label corresponding to the controller to initiate a capability of sending the radio frequency signal, or control the RFID label corresponding to the controller to send a radio frequency signal that can be identified by the reader; and

the RFID label is configured to: under the control of the corresponding controller, initiate the capability of sending the radio frequency signal, or under the control of the corresponding controller, send the radio frequency signal that can be identified by the reader, the radio frequency signal at least carrying the identity identification information.

It can be seen from the foregoing technical solution that, in the method, device and system for identifying and sending a radio frequency signal provided in the embodiments of the present invention, the control signal is sent to the radio frequency signal sending device by the reader, so that the radio frequency signal sending device sends the radio frequency signal according to the control signal, where the radio frequency signal at least carries the identity identification information; the radio frequency signal sent by the radio frequency signal sending device is received, and the identity identification information in the radio frequency signal is acquired, so as to implement the control of the reader on the RFID label, so that the RFID label can send the radio frequency signal according to the instruction of the reader. When multiple RFID labels exist, the RFID labels may be identified according to a set sequence, thereby avoiding the increase of circuit complexity and apparatus costs caused by disposing antennas respectively corresponding to the RFID labels on the reader, and improving the identification effect on multiple RFID labels.

### BRIEF DESCRIPTION OF THE DRAWINGS

To illustrate the technical solutions in the embodiments of the present invention or in the prior art more clearly, the following briefly describes the accompanying drawings required for describing the embodiments or the prior art. Apparently, the accompanying drawings in the following description show some embodiments of the present invention, and a person skilled in the art can derive other drawings from these accompanying drawings without creative efforts.

FIG. 1 is a schematic flow chart of a method for identifying a radio frequency signal provided in an embodiment of the present invention;

FIG. 2 is a schematic flow chart of a method for sending a radio frequency signal provided in an embodiment of the present invention;

FIG. 3 is a schematic structural diagram of a reader provided in an embodiment of the present invention;

FIG. 4 is a schematic structural diagram of an RFID label provided in an embodiment of the present invention;

FIG. 5 is a schematic structural diagram of a radio frequency signal sending device provided in an embodiment of the present invention;

FIG. 6 is a schematic structural diagram of another radio frequency signal sending device provided in an embodiment of the present invention;

FIG. 7 is a schematic structural diagram of still another radio frequency signal sending device provided in an embodiment of the present invention;

FIG. 8 is a schematic structural diagram of yet another radio frequency signal sending device provided in an embodiment of the present invention;

FIG. 9 is a schematic structural diagram of a radio frequency identification system provided in an embodiment of the present invention;

FIG. 10 is a schematic structural diagram of another radio frequency identification system provided in an embodiment of the present invention; and

FIG. 11 is a schematic structural diagram of an optical fiber wiring system provided in an embodiment of the present invention.

### DETAILED DESCRIPTION OF THE EMBODIMENTS

To make the objectives, technical solutions, and advantages of the present invention more comprehensible, the following clearly and completely describes the technical solutions according to the embodiments of the present invention with reference to the accompanying drawings in the embodiments of the present invention. Apparently, the embodiments in the following description are merely a part rather than all of the embodiments of the present invention. All other embodiments obtained by a person skilled in the art based on the embodiments of the present invention without creative efforts shall fall within the protection scope of the present invention.

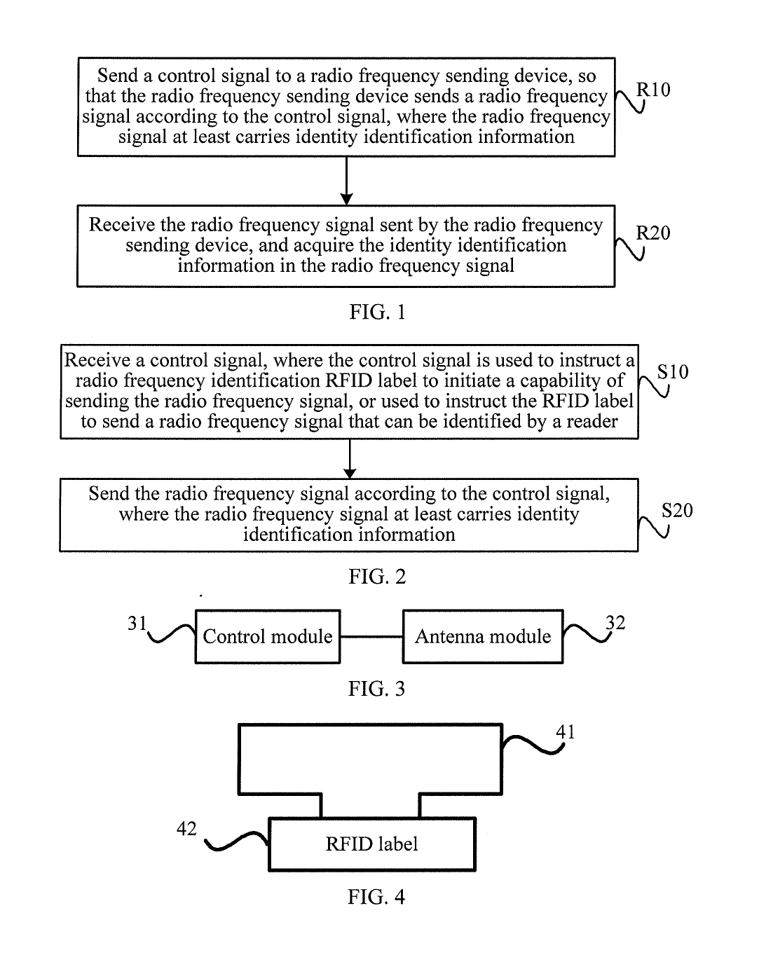

Referring to FIG. 1, a schematic flow chart of a method for identifying a radio frequency signal provided in an embodiment of the present invention is shown. The method for identifying the radio frequency signal provided in this embodiment may specifically applicable to an identification procedure of multiple radio frequency identification (RFID) labels, and may be executed through a reader. As shown in FIG. 1, the method for identifying the radio frequency signal provided in this embodiment specifically includes:

Step R10: Send a control signal to a radio frequency signal sending device, to enable the radio frequency signal sending device to send a radio frequency signal according to the control signal, where the radio frequency signal at least carries identity identification information.

In the embodiment of the present invention, the radio frequency signal sending device “sends the radio frequency signal according to the control signal” may refer to that the radio frequency signal sending device sends or does not send the radio frequency signal according to the control signal, or may refer to, send, according to the control signal, a radio frequency signal carrying an identification that can be identified by the reader.

Implementation 1: The radio frequency signal sending device in the embodiment of the present invention may include an RFID label, sending the control signal to the radio frequency signal sending device may be implemented as sending a first control signal to the RFID label, the first control signal enables the RFID label to accordingly initiate a capability of sending a radio frequency signal and to send the radio frequency signal. Specifically, a switch may be added in the antenna of the RFID label; when the switch is in an open state, the RFID label cannot send the radio frequency signal, and when the switch receives the first control signal, the switch is closed under the control of the first control signal, so that the RFID label can send the radio frequency signal. In a specific application, it can be set initially that switches of all the RFID labels are in the open state; when the reader intends to read a certain RFID label, the reader sends the first control signal to the label, so that the label may initiate the capability of sending the radio frequency signal, and other labels do not have the capability. Therefore, even multiple labels exist in a control range of the reader, and the reader can only receive the radio frequency signal of the RFID label from which the reader intends to acquire information, thereby implementing accurate location and identification of the label.

Implementation 2: In addition to the RFID label, the radio frequency signal sending device in the embodiment of the present invention may further include a controller, and the reader indirectly controls the capability of sending the radio frequency signal of the RFID label through the controller. Specifically, the reader may send a second control signal to the controller, so that the controller controls the RFID label to initiate a capability of sending the radio frequency signal and to send the radio frequency signal. For example, in the foregoing implementation, when the controller receives the second control signal, the switch in the RFID label in the control range of the controller is closed, so as to initiate the capability of sending the radio frequency signal of the RFID label.

Implementation 3: The radio frequency signal sending device in the embodiment of the present invention may include an RFID label, the reader may directly send a third control signal to the RFID label, so that the RFID label sends a radio frequency signal according to the third control signal, where the radio frequency signal carries identity identification information and a distinguishing identification. In this implementation, the radio frequency signal sent by the RFID label may carry an identification used to distinguish the signal from other radio frequency signals, and even multiple labels exist in a reading range of the reader, the reader may also read, through the distinguishing identification, the identity identification information of the label the reader wants to locate. In specific implementation, a state identification may be added in the radio frequency signal to serve as the distinguishing identification, the state identification is used to indicate whether the radio frequency signal is valid or invalid, for example, the state identification may be an identification bit. When the value of the identification bit is “1”, it indicates that the radio frequency signal is valid, and when the value of the identification bit is “0”, it indicates that the radio frequency signal is invalid. In an initial state, all labels may be in the invalid state, and after the label receives the control signal, the value of the identification bit of the label changes to 1, so that the reader may acquire valid identity identification information through the identification bit. Definitely, the distinguishing identification may also be set as an identification bit of the identity identification information.

Implementation 4: On the basis of Implementation 3, the radio frequency signal sending device in the embodiment of the present invention may further include a controller, that is, the reader directly sends the control signal to the controller, and indirectly controls the RFID label through the controller, so that the radio frequency signal sent by the RFID label carries identity identification information and a distinguishing identification. The specific implementation may be obtained through the foregoing embodiment, and is not repeated herein.

Step R20: Receive the radio frequency signal sent by the radio frequency signal sending device, and acquire the identity identification information in the radio frequency signal.

Corresponding to Implementation 1 and Implementation 2 in the step R10, the reader receives a radio frequency signal. The radio frequency signal is a control signal sent by the RFID label under the control of the reader through the control signal, and the signal is sent after the RFID label initiates the capability of sending the radio frequency signal.

Corresponding to Implementation 3 and Implementation 4 in the step R10, the reader may receive one or more radio frequency signals (the number of the RFID labels in the range of the reader is equal to the number of radio frequency signals that might be received by the reader), and by acquiring the distinguishing identification in the radio frequency signal, the identity identification information in the radio frequency signal the distinguishing identification of which is different from that of other radio frequency signals may be acquired. For the distinguishing identification, the reader sends, directly or through the controller, the control signal to the RFID label, indicating the RFID label to add or change the distinguishing identification in the radio frequency signal, so the reader may find the identity identification information intended to be read through the distinguishing identification. For example, the reader may determine the validity of the radio frequency signal according to the state identification in the received radio frequency signal.

According to the method in the embodiment of the present invention, when multiple RFID labels exist in the reading range of the reader, if the user needs to know the identity identification information of one RFID label, where the RFID label herein is referred to as a set RFID label component for short, a control signal may be sent to the set RFID label or the control signal may be sent to a controller corresponding to the set RFID label to indirectly control the set RFID label, so that the set RFID label changes a state of sending the radio frequency signal. For example, in an initial state, all the RFID labels cannot send the radio frequency signal. When the set RFID label receives the control signal sent by the reader or receives the control of the controller, the set RFID label may initiate the capability of sending the radio frequency signal, and the user may receive the radio frequency signal through the reader and acquire the identity identification information in the radio frequency signal. For another example, in the initial state, all the RFID labels can send the radio frequency signal, but the state identifications in the radio frequency signals are all “0”, indicating that the radio frequency signals are invalid. When the set RFID label receives the control signal sent by the reader or receives the control of the controller, the set RFID label changes the state identification to “1”, indicating that the radio frequency signal is valid. In one or more radio frequency signals received by the reader, only the state identification in the radio frequency signal sent by the set RFID label is “1”, and therefore, the set RFID label may be determined, and the identity state identification in the radio frequency signal is acquired. By using the foregoing method, even multiple RFID labels exist in the reading range of the reader, the location on the set RFID label can be implemented. By applying the method of the embodiment of the present invention repeatedly, the identity state identifications in the RFID labels may be acquired sequentially according to a sequence set by the user.

It should be noted that, the first, second, and third control signals are used for distinguishing only, and do not intend to limit the sequence.

The method provided in the embodiments of the present invention is illustrated by using specific examples hereunder.

### Example 1

### Label Location, that is, Finding a Certain Label Through a Controller with a Known Location

First step: Operate a controller with a known location, where the controller controls a label state in its controllable range to be changed, that is, enable the distinguishing identification (state identification) in the radio frequency signal sent by the label to be 1, indicating valid.

Second step: The reader reads all labels in its reading range.

Third step: Find a radio frequency signal having distinguishing identification different from that of other radio frequency signals.

Fourth step: The location of the label to which the radio frequency signal obtained in the third step belongs is in the control range of the current controller, and the label may be known by acquiring the identity identification information in the radio frequency signal, thereby completing the label location.

It should be noted that, the example may have some variation in the spirit of the embodiment of the present invention, for example, the reader may first read states of all labels in its reading range, and operate a controller with a known location, so that the labels in the control range of the controller have their states changed and other labels remain the states unchanged, then the reader reads the sates of all the labels in its reading range again, and compares the former read data and the later read data, where the label the state of which has changed is the label in the control range of the controller, thereby completing the label location. Definitely, if the reader knows the states of all the labels at the very beginning, for example, the labels are set to have all the state identification being 0, the first step may be omitted.

### Example 2

### Read the Labels According to a Specified Sequence

First step: Select a label according to a specified sequence (the sequence may be designated artificially), find a controller corresponding to the label, and operate the controller, so that the label state is changed.

Second step: The reader reads all the labels in the range thereof (definitely, the reading range of the reader at this time needs to include the label the state of which has changed in the first step, and in the specific implementation, the step may be implemented through controlling a distance between the reader and the label).

Third step: The reader finds the label the state of which has changed, and the label is the label currently required to be read.

Fourth step: Select a next label, and repeat the foregoing steps.

It should be noted that, the first step may be that the reader directly controls the label without using the controller, and the specific implementation is illustrated in the foregoing embodiment of the present invention, which is not repeated herein. In addition, Example 2 may also have some adjustment or improvement according to the variation of Example 1, which are easily obtained by a person skilled in the art on the basis of the method and examples introduced in the embodiment of the present invention, and are not repeated herein.

In the method for identifying a radio frequency signal provided in this embodiment, by sending the control signal to the radio frequency signal sending device, the radio frequency signal sending device sends the radio frequency signal according to the control signal, the radio frequency signal at least carries the identity identification information; the radio frequency signal sent by the radio frequency signal sending device is received, and the identity identification information in the radio frequency signal is acquired, thereby implementing the control of the reader to the RFID label. When multiple RFID labels exist, the RFID labels may be identified according to a set sequence, thereby avoiding the increase of circuit complexity and apparatus costs caused by disposing antennas respectively corresponding to the RFID labels on the reader, and improving the identification effect on multiple RFID labels.

Corresponding to the method for identifying a radio frequency signal in the embodiment of the present invention, FIG. 2 is a schematic flow chart of a method for sending a radio frequency signal provided in an embodiment of the present invention. The method for sending the radio frequency signal provided in the embodiment of the present invention may cooperate with the method for identifying the radio frequency signal provided in the foregoing embodiment to implement the procedure for identifying multiple RFID labels. The method for sending the radio frequency signal provided in the embodiment of the present invention may be executed by a radio frequency signal sending device, the radio frequency signal sending device here may be an RFID label, and may also be a combined device of a controller and an RFID label. In the later situation, the controller is configured to receive the control signal sent by the reader to control the RFID label, and the RFID label is configured to send the radio frequency signal to the reader. As shown in FIG. 2, the method for sending the radio frequency signal provided in the embodiment of the present invention specifically includes:

Step S10: Receive a control signal, where the control signal is used to instruct a radio frequency identification (RFID) label to initiate a capability of sending a radio frequency signal, is used to instruct the RFID label to send a radio frequency signal that can be identified by the reader.

Step S20: Send the radio frequency signal according to the control signal, where the radio frequency signal at least carries identity identification information.

In one implementation, the radio frequency signal sending device receives a first control signal, where the first control signal is used to instruct the RFID label to initiate a capability of sending a radio frequency signal; initiates, according to the first control signal, the capability of sending the radio frequency signal, and sends the radio frequency signal, where the radio frequency signal carries identity identification information. For example, a switch may be configured on the RFID label, the switch may be opened or closed under the control of the control signal in a certain frequency range, and the reader may implement control on different switches through sending control signals of different frequencies.

In another implementation, the radio frequency signal sending device receives a second control signal, where the second control signal is used to instruct RFID label to send a radio frequency signal that can be identified by the reader; sends the radio frequency signal according to the second control signal, where the radio frequency signal carries identity identification information and distinguishing identification, and the distinguishing identification is used to enable the reader to distinguish the received radio frequency signal.

It should be understood that, when the radio frequency signal sending device includes the RFID label only, the reader may directly send the control signal to the RFID label; and when the radio frequency signal sending device further includes the controller, the reader may send the control signal to the controller, and the controller controls the RFID label to send the radio frequency signal.

FIG. 3 is a schematic structural diagram of a reader provided in an embodiment of the present invention. As shown in FIG. 3, the reader provided in this embodiment may implement the steps of the method for identifying the radio frequency signal provided in any embodiment of the present invention, which is not repeated herein. The reader provided in this embodiment specifically includes a control module 31 and an antenna module 32 connected to the control module 31.

The control module 31 is configured to generate a control signal, and send the control signal to the antenna module 32; and receive a radio frequency signal from the antenna module 32, and acquire identity identification information in the radio frequency signal. The control module 31 may generate the control signal corresponding to a label according to the information for indicating the RFID label to be located.

The antenna module 32 is configured to send the control signal to a radio frequency signal sending device, so that the radio frequency signal sending device sends the radio frequency signal according to the control signal, where the radio frequency signal at least carries identity identification information; and receives the radio frequency signal sent by the radio frequency signal sending device, and sends the radio frequency signal to the control module 31.

Specifically, the control module 31 may include a micro control unit (MCU) and a radio frequency unit, and the radio frequency unit may be integrated in the micro control unit. The radio frequency unit is configured to modulate control information generated by the micro control unit into a signal suitable to be sent by the antenna module 32.

In one implementation, when the radio frequency signal sending device includes the RFID label, but does not include the controller, the control module 31 may generate a first control signal, and sends the first control signal to the antenna module 32, the antenna module 32, after receiving the first control signal, sends the first control signal to the RFID label, so that the RFID label initiates a capability of sending the radio frequency signal according to the first control signal and sends the radio frequency signal, the antenna module 32 receives the radio frequency signal sent by the RFID label, and sends the radio frequency signal to the control module 31, and the control module 31 receives the radio frequency signal from the antenna module 32, and acquires the identity identification information in the radio frequency signal.

In another implementation, when the radio frequency signal sending device includes the RFID label and the controller, the control module 31 may generate a second control signal, and send the second control signal to the antenna module 32, and the antenna module 32 sends the second control signal to the controller of the radio frequency signal sending device, so that the controller controls the RFID label to initiate a capability of sending the radio frequency signal and send the radio frequency signal, and the antenna module 32 receives the radio frequency signal sent by the RFID label, and sends the radio frequency signal to the control module 31.

In a third implementation, when the radio frequency signal sending device includes the RFID label, the control module 31 is specifically configured to generate a third control signal, and send the third control signal to the antenna module 32; the antenna module 32 directly sends the third control signal to the RFID label, so that the RFID label sends the radio frequency signal according to the third control signal, where the radio frequency signal carries identity identification information and distinguishing identification; the antenna module 32 receives the radio frequency signal sent by at least one RFID label, and sends the radio frequency signal to the control module 31; and the control module 31 receives the radio frequency signal from the antenna module 32, acquires the distinguishing identification in the radio frequency signal, and acquires the identity identification information in the radio frequency signal the distinguishing identification of which is different from that of other radio frequency signals.

In a fourth implementation, when the radio frequency signal sending device further includes the controller, the reader may send a fourth control signal to the controller, and the controller controls the RFID label to send the radio frequency signal carrying distinguishing identification to the reader. The specific implementation is as follows: the control module 31 is specifically configured to: generate a fourth control signal, and send the fourth control signal to the antenna module 32; and receive the radio frequency signal from the antenna module, acquire the distinguishing identification in the radio frequency signal, and acquire the identity identification information in the radio frequency signal the distinguishing identification of which is different from that of other radio frequency signals; the antenna module 32 is specifically configured to: send the fourth control signal to the controller, so that the controller controls the RFID label to send the radio frequency signal according to the fourth control signal, where the radio frequency signal carries the identity identification information and the distinguishing identification; and receive the radio frequency signal sent by at least one RFID label, and send the radio frequency signal to the control module 31.

It should be understood that, the first, second, and third control signals are only used for distinguishing, and do not intend to limit the sequence.

In the reader provided in this embodiment, by directly controlling the RFID label or indirectly controlling the RFID label through a controller, the control of the reader on the RFID label intended to be read is implemented, so that only the RFID label sends the radio frequency signal or the RFID label sends the radio frequency signal the label of which is different from other labels, thereby implementing the accurate location on the RFID label. When multiple RFID labels exist, the RFID labels may be identified according to a set sequence by repeatedly using the method provided in the embodiment of the present invention, thereby avoiding the increase of circuit complexity and apparatus costs caused by disposing antennas respectively corresponding to the RFID labels on the reader, and improving the identification effect on multiple RFID labels.

Correspondingly, an embodiment of the present invention provides a radio frequency identification (RFID) label. Refer to FIG. 4, the RFID label includes an antenna 41 and an RFID chip 42 connected to the antenna 41.

The antenna 41 is configured to: receive a control signal, where the control signal is used to instruct the radio frequency identification (RFID) label to initiate a capability of sending the radio frequency signal, and the signal is used to instruct the RFID label to send a radio frequency signal that can be identified by the reader; receive the radio frequency signal sent by the RFID chip 42, and send the radio frequency signal to the reader.

The RFID chip 42 is configured to: perform one of the following two operations according to the control signal: initiating a capability of sending the radio frequency signal and generating the radio frequency signal that can be identified by the reader according to the control signal, and send the radio frequency signal to the antenna 41, where the radio frequency signal at least carries identity identification information.

Specifically, in an implementation, the antenna 41 may receive a first control signal, where the first control signal is used to instruct the RFID label to initiate a capability of sending the radio frequency signal; correspondingly, the RFID chip 42 may initiate the capability of sending the radio frequency signal according to the first control signal, and send the radio frequency signal to the antenna 41, where the radio frequency signal carries identity identification information. In another implementation, the antenna 41 may receive a second control signal, where the second control signal is used to instruct the RFID label to send the radio frequency signal that can be identified by the reader; correspondingly, the RFID chip 42 may generate a radio frequency signal according to the second control signal, and send the radio frequency signal to the antenna 41, where the radio frequency signal carries identity identification information and distinguishing identification, and the distinguishing identification is used to enable the reader to distinguish the received radio frequency signal.

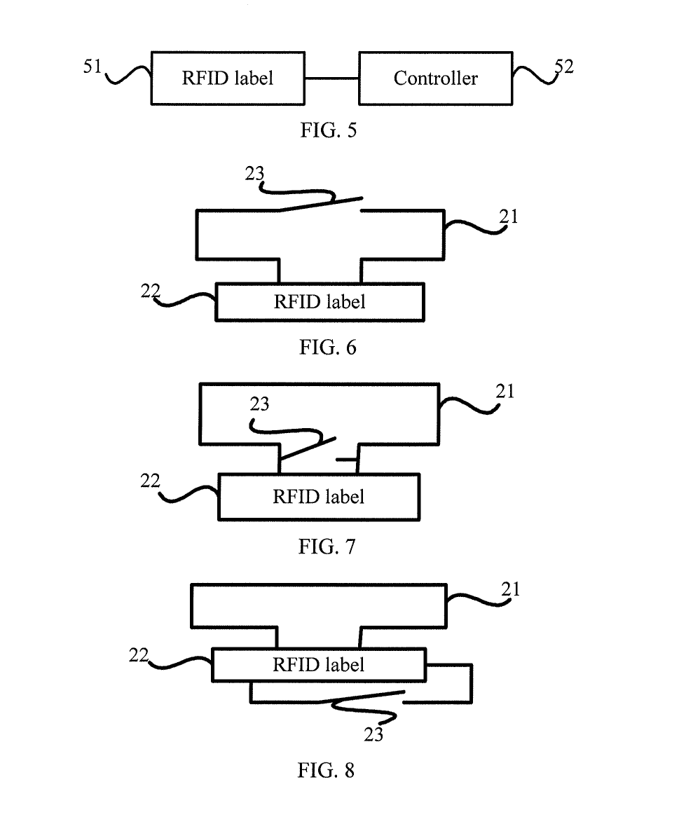

An embodiment of the present invention further provides a radio frequency signal sending device, as shown in FIG. 5, the device includes a radio frequency identification (RFID) label 51 and a controller 52.

The controller 52 is configured to: receive a control signal, initiate a capability of sending the radio frequency signal of the RFID label 5 according to the control signal, or according to the control signal, instruct the RFID label 51 to send the radio frequency signal that can be identified by the reader.

The RFID label 51 is configured to: send the radio frequency signal according to control of the controller 51, where the radio frequency signal at least carries identity identification information.

Specifically, the controller 52 is configured to: receive a first control signal, according to the first control signal, control the RFID label 51 to send the radio frequency signal that can be identified by the reader; the RFID label 51 is configured to: send the radio frequency signal according to the control of the controller 52, where the radio frequency signal carries identity identification information and distinguishing identification, and the distinguishing identification is used to enable the reader to distinguish the received radio frequency signal.

The radio frequency signal sending device provided in the embodiment of the present invention may only include the RFID label, and may also include RFID labels and controllers that correspond to the RFID labels respectively. The radio frequency signal sending device is introduced hereunder through a specific embodiment: a switch is configured on the RFID label, the switch is opened or closed under the control of the control signal, so as to control the RFID label to close or initiate a capability of sending the radio frequency signal, or control the RFID label to send the radio frequency signal that can be identified by the reader; the controller is configured to receive the control signal, and control the switch on the RFID label to open or close according to the control signal.

In a specific implementation, as shown in FIG. 6, the switch is connected in series to an antenna of the radio frequency identification label, and is opened or closed under the control of the control signal to enable the antenna in an open state or closed state. A switch 23 is connected in series to the antenna 21. When the switch 23 is open, a loop of the antenna 21 is disconnected, so the RFID chip 22 cannot send the radio frequency signal through the antenna 21. When the switch 23 is closed, the loop of the antenna 21 is connected, so the RFID chip 22 may send the radio frequency signal through the antenna 21. When the reader needs to read the identity identification information of a certain RFID label, the reader may send the control signal to control the switch 23 to be closed, so the RFID label may send the radio frequency signal carrying the identity identification information, thereby implementing the identification of the reader on the RFID label.

In another specific implementation, as shown in FIG. 7, a switch is connected in parallel to the antenna of the radio frequency identification label, and is opened or closed under the control of the control signal so as to enable the antenna to be in an ON state or in a short-circuit state. A switch 23 is connected in parallel to the antenna 21. When the switch 23 is closed, a loop of the antenna 21 is short-circuited, so the RFID chip 22 cannot send the radio frequency signal through the antenna 21. When the switch 23 is open, the loop of the antenna 21 is connected, so the RFID chip 22 can send the radio frequency signal through the antenna 21. When the reader needs to read the identity identification information of a certain RFID label, the reader may send the control signal to control the switch 23 to be open, so the RFID label may send the radio frequency signal carrying the identity identification information, thereby implementing the identification of the reader on the RFID label.

In a third specific implementation, as shown in FIG. 8, the switch is configured on a radio frequency identification chip of the RFID label, and is closed under the control of the control signal to control that the radio frequency signal sent by the radio frequency identification chip carries distinguishing identification, where the distinguishing identification is used to enable the reader to distinguish the received radio frequency signal. A switch 23 is configured on the RFID chip 22. The RFID chip 22 may detect a state of the switch 23, if it is detected that the state of the switch 23 is closed, set the distinguishing identification in the sent radio frequency signal to “1”, if it is detected that the state of the switch 23 is open, set the distinguishing identification in the sent radio frequency signal to “0”. The mapping between content of the distinguishing identification and the state of the switch 23 may be set specifically according to actual identification agreement, for example, it can be set that, when the state identification is 1, the radio frequency signal sent by the radio frequency identification label is valid, and when the state identification is 0, the radio frequency signal sent by the radio frequency identification label is invalid. When the state identification in the radio frequency signal received by the reader is 1, required information such as required identity identification information is obtained from the radio frequency signal; and when the state identification in the radio frequency signal received by the reader is 0, the valid radio frequency signal may be omitted, and no processing is performed.

It should be understood that, the control signal may be directly sent to the RFID label, for example, switches of different radio frequency identification labels are controlled by control signals of different frequencies, and therefore, the reader may, by sending the control signal of a certain frequency, control the setting of the switch of an RFID label to close or open; the control signal may also be sent to a controller, and the reader controls a corresponding RFID label corresponding to the controller through the controller. For example, the switch is a reed switch, the controller is an electromagnet, and when receiving the control signal (may be an electrical signal) sent by the reader, the electromagnet generates an electromagnetic field, so as to close the switch. In the embodiment of the present invention, if the location of the controller is known, the control signal may be sent to the controller, so that the controller controls the switch of the RFID label in the control range thereof to close, and the reader receives the radio frequency signal of the RFID label, and acquires the identity identification information in the radio frequency signal, thereby performing location about which label is located in the control range of the controller.

In the foregoing embodiment, the switch 23 may be a reed switch, and correspondingly, the controller may be an electromagnet configured to generate an electromagnetic field when receiving the control signal, so as to close the switch. The reed switch is a magnet-sensitive switch, so the control signal may be an electrical signal, so that the electromagnet generates a magnetic field after being electrified, the reed switch is closed under the function of the magnetic field, thereby implementing the control on the reed switch. It should be understood that, one-to-one mapping exists between the control signal sent by the reader and the electromagnet, that is, each control signal is corresponding to a unique electromagnet, an electromagnet is controlled by only one control signal, the electromagnet only functions to the reed switch in the magnetic range thereof, and therefore, the set position of the electromagnet should be close to the set position of the corresponding RFID label.

It should be noted that, the switch 23 may also adopt another form, such as a photosensitive switch, an acoustic sensitive switch, a photoelectric switch, a magnetic switch, and a mechanical contact switch, which is not limited to this embodiment.

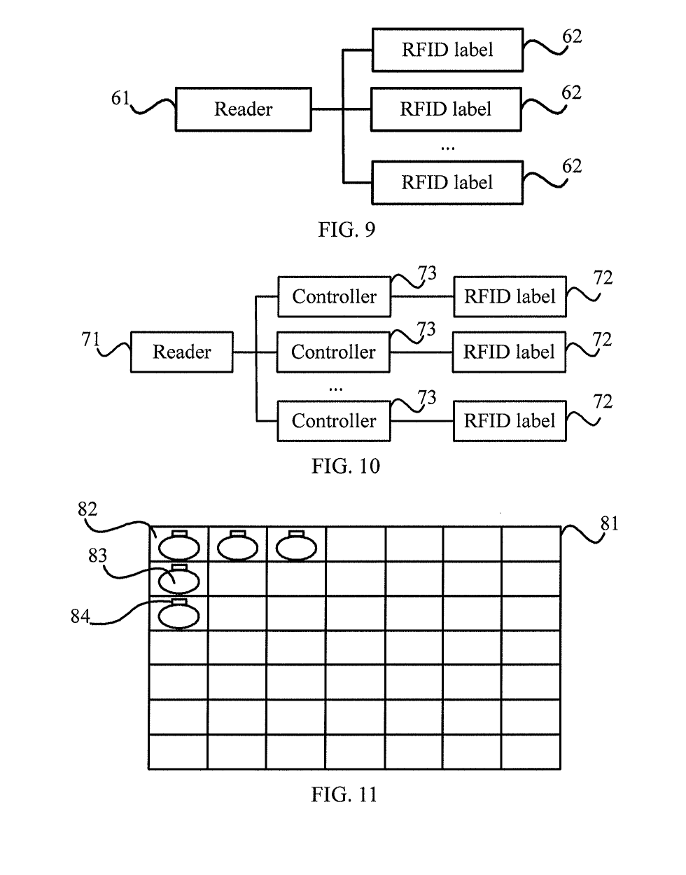

FIG. 9 is a schematic structural diagram of a radio frequency identification system provided in an embodiment of the present invention. As shown in FIG. 9, the radio frequency identification system provided in this embodiment specifically includes at least one reader 61 and multiple radio frequency identification (RFID) labels 62, where:

the reader 61 is configured to: send a control signal to the RFID label 62, so that the RFID label 62 send a radio frequency signal according to the control signal; receive the radio frequency signal sent by the RFID label 62, and acquire identity identification information in the radio frequency signal; and

the RFID label 62 is configured to: receive the control signal, where the control signal is used to instruct the RFID label 62 to initiate a capability of sending the radio frequency signal, or is used to instruct the RFID label 62 to send a radio frequency signal that can be identified by the reader 61; and send the radio frequency signal according to the control signal, where the radio frequency signal at least carries identity identification information.

It should be noted that, the procedure that the interaction between the reader 61 and the RFID labels 62 implements the identification of multiple radio frequency identification label components is similar to the implementation procedure described in the foregoing embodiment, and has similar technical effects, which are not repeated herein.

FIG. 10 is a schematic structural diagram of another radio frequency identification system provided in an embodiment of the present invention. As shown in FIG. 10, the system includes at least one reader 71, multiple radio frequency identification (RFID) labels 72, and multiple controllers 73 that correspond to the RFID labels respectively 72, where:

the reader 71 is configured to: send a control signal to the controller 73, so that the controller 73 controls a RFID label 72 corresponding to the controller to send a radio frequency signal; receive the radio frequency signal sent by the RFID label 72, and acquire identity identification information in the radio frequency signal;

the controller 73 is configured to: receive the control signal sent by the reader 71, and according to the control signal, control the RFID label 72 corresponding to the controller to initiate a capability of sending the radio frequency signal, or control the RFID label 72 corresponding to the controller to send a radio frequency signal that can be identified by the reader 71; and

the RFID label 72 is configured to: initiate the capability of sending the radio frequency signal under the control of the corresponding controller 73, or send the radio frequency signal that can be identified by the reader 71 under the control of the corresponding controller 73, where the radio frequency signal at least carries identity identification information.

It should be noted that, the procedure that the interaction between the reader 71 and the RFID labels 72 through the controller 73 implements the identification of multiple radio frequency identification label components is similar to the implementation procedure described in the foregoing embodiment, and has similar technical effects, which are not repeated herein.

The radio frequency identification method and device provided in the embodiments of the present invention may be applicable to an optical fiber wiring system, as shown in FIG. 11, a schematic structural diagram of an optical fiber wiring system provided in an embodiment of the present invention is shown. The system includes an optical fiber wiring frame 81, the optical fiber wiring frame 81 is configured with multiple port adapters 82, each of the port adapters 82 is disposed with an optical fiber connector 83, and the system is characterized in that: the optical fiber wiring system further includes at least one reader (not shown) provided in the embodiment of the present invention, and multiple RFID labels 84 provided in the embodiment of the present invention. Each of the optical fiber connectors 83 is configured with an RFID label 84, and a radio frequency identification chip of the RFID label 84 stores identity identification information corresponding to the optical fiber connector 83.

Specifically, each port adapter 82 has a fixed location on the optical fiber wiring frame 81. The port adapter 82 is configured with an optical fiber connector 83, so that two optical fibers are connected through the optical fiber connector 83. The optical fiber connector 83 is configured with the RFID label 84, the RFID label 84 stores the identity identification information corresponding to the optical fiber connector 83, and the identity identification information may specifically include information of the optical fiber to which the optical fiber connector 83 is connected. By acquiring the identity identification information, the optical fiber corresponding to the optical fiber connector 83 may be known.

If the user intends to acquire information of an optical fiber to which the optical fiber connector 83 of a certain port adapter 82 on the optical fiber wiring frame 81 may insert, the user may send the control signal corresponding to the optical fiber connector 83 through reader, so as to change the state of sending the radio frequency signal of the RFID label 84 on the optical fiber connector 83, for example, the RFID label 84 initiates a capability of sending the radio frequency signal, or the RFID label 84 sends the radio frequency signal that can be identified by the reader. The reader acquires the identity identification information in the radio frequency signal sent by the RFID label 84, so as to insert the optical fiber according to the identity identification information. By analogy, the user may implement insertion of the optical fibers according to wiring requirement.

In the optical fiber wiring system provided in this embodiment, by configuring the RFID label 84 on the optical fiber connector 83, the RFID label 84 is controlled by the reader, so as to acquire the identity identification information in the RFID label 84. Multiple optical fiber connectors 83 exist on the optical fiber wiring system, so the optical fibers may be inserted sequentially according to the actual wiring requirement, thereby improving the wiring efficiency.

In another implementation, controllers may be configured for the RFID labels. Each port adapter 82 is configured with a controller (not shown), the controller is configured to receive the control signal sent by the reader, and according to the control signal, initiate a capability of a corresponding RFID label (the label is the label on the optical fiber connector configured on the port adapter) about sending the radio frequency signal, or according to the control signal, instruct the corresponding RFID label to send the radio frequency signal that can be identified by the reader. In this embodiment, a switch may be configured on the RFID label, so as to be controlled by the control signal. The switch may be a reed switch, and may be configured to be connected to the antenna in series or in parallel, and the controller may be an electromagnet.

It should be noted that, this embodiment provides an application scenario of the radio frequency identification system, but the present invention is not limited thereto. In another application scenario, for example, a conference site, the RFID label may be allocated for each participant entering the site, and the RFID label stores identity information of the participant. After the participants sit in the right seats, if an administrator intends to know the information of the participant on each seat, the administrator may send a control signal through a reader to change the state of a corresponding RFID label about sending the radio frequency signal. The reader receives the radio frequency signal, and acquires identity information in the radio frequency signal.

A person skilled in the art should understand that all or part of the steps of the methods in the embodiments may be implemented by a program instructing relevant hardware. The program may be stored in a computer readable storage medium. When the program runs, the above steps of the methods in the embodiments are performed. The storage medium may be any medium capable of storing program codes, such as a ROM, a RAM, a magnetic disk, or an optical disk.

Finally, it should be noted that the above embodiments are merely intended for describing the technical solutions of the present invention other than limiting the present invention. Although the present invention is described in detail with reference to the foregoing embodiments, a person skilled in the art should understood that they can still make modifications to the technical solutions described in the foregoing embodiments, or make equivalent substitutions to some technical features thereof, without departing from the spirit and scope of the technical solutions of the embodiments of the present invention.

What is claimed is:

1. A method for identifying a radio frequency signal, comprising:
sending a control signal to a radio frequency signal sending device, so that the radio frequency signal sending device sends a radio frequency signal according to the control signal, the radio frequency signal at least carrying identity identification information; and
receiving the radio frequency signal sent by the radio frequency signal sending device, and acquiring the identity identification information in the radio frequency signal.

2. The method according to claim 1, wherein, the radio frequency signal sending device comprises a radio frequency identification (RFID) label,
the sending the control signal to the radio frequency signal sending device, so that the radio frequency signal sending device sends the radio frequency signal according to the control signal, specifically comprises:
sending a first control signal to the RFID label, so that the RFID label initiates a capability of sending a radio frequency signal and sends a radio frequency signal according to the first control signal.

3. The method according to claim 1, wherein, the radio frequency signal sending device comprises an RFID label and a controller,
the sending the control signal to the radio frequency signal sending device, so that the radio frequency signal sending device sends the radio frequency signal according to the control signal, specifically comprises:
sending a second control signal to the controller, so that the controller controls the RFID label to initiate a capacity of sending a radio frequency signal and sends a radio frequency signal.

4. The method according to claim 1, wherein, the radio frequency signal sending device comprises an RFID label,
the sending the control signal to the radio frequency signal sending device, so that the radio frequency signal sending device sends the radio frequency signal according to the control signal, the radio frequency signal at least carrying the identity identification information, specifically comprises:
sending a third control signal to the RFID label, so that the RFID label sends the radio frequency signal according to the third control signal, the radio frequency signal carrying the identity identification information and a distinguishing identification.

5. The method according to claim 1, wherein, the radio frequency signal sending device comprises an RFID label and a controller,
the sending the control signal to the radio frequency signal sending device, so that the radio frequency signal sending device sends the radio frequency signal according to the control signal, the radio frequency signal at least carrying the identity identification information, specifically comprises:
sending a fourth control signal to the controller, so that the controller controls the RFID label to send the radio frequency signal, the radio frequency signal carrying the identity identification information and distinguishing identification.

6. The method according to claim 4, wherein, the receiving the radio frequency signal sent by the radio frequency signal sending device, and acquiring the identity identification information in the radio frequency signal, specifically comprises:
receiving the radio frequency signal sent by at least one RFID label, and acquiring the distinguishing identification in the radio frequency signal; and
acquiring identity identification information in a radio frequency signal the distinguishing identification of which is different from that of other radio frequency signals.

7. A reader, comprising a control module and an antenna module connected to the control module; wherein
the control module is configured to: generate a control signal, and send the control signal to the antenna module; and receive a radio frequency signal from the antenna module, and acquire identity identification information in the radio frequency signal; and
the antenna module is configured to: send the control signal to a radio frequency signal sending device, so that the radio frequency signal sending device sends the radio frequency signal according to the control signal, the radio frequency signal at least carrying the identity identification information; and receive the radio frequency signal sent by the radio frequency signal sending device, and send the radio frequency signal to the control module.

8. The reader according to claim 7, wherein, the radio frequency signal sending device comprises an RFID label,
the control module is specifically configured to: generate a first control signal, and send the first control signal to the antenna module; and receive the radio frequency signal from the antenna module, and acquire the identity identification information in the radio frequency signal; and
the antenna module is specifically configured to: send the first control signal to the RFID label, so that the RFID label initiates a capability of sending the radio frequency signal according to the first control signal and sends the radio frequency signal; and receive the radio frequency signal sent by the RFID label, and send the radio frequency signal to the control module.

9. The reader according to claim 7, wherein, the radio frequency signal sending device comprises an RFID label and a controller,
the control module is specifically configured to: generate a second control signal, and send the second control signal to the antenna module; and receive the radio frequency signal from the antenna module, and acquire the identity identification information in the radio frequency signal; and
the antenna module is specifically configured to: send the second control signal to the controller, so that the controller controls the RFID label to initiate a capability of sending the radio frequency signal and send the radio frequency signal; and receive the radio frequency signal sent by the RFID label, and send the radio frequency signal to the control module.

10. The reader according to claim 7, wherein, the radio frequency signal sending device comprises an RFID label,
the control module is specifically configured to: generate a third control signal, and send the third control signal to the antenna module; and receive the radio frequency signal from the antenna module, acquire distinguishing identification in the radio frequency signal, and acquire identity identification information in a radio frequency signal the distinguishing identification of which is different from that of other radio frequency signals; and
the antenna module is specifically configured to: send the third control signal to the RFID label, so that the RFID label sends the radio frequency signal according to the third control signal, the radio frequency signal carrying the identity identification information and the distinguishing identification; and receive the radio frequency signal sent by at least one RFID label, and send the radio frequency signal to the control module.

11. The reader according to claim 7, wherein, the radio frequency signal sending device comprises an RFID label and a controller,
the control module is specifically configured to: generate a fourth control signal, and send the fourth control signal to the antenna module; and receive the radio frequency signal from the antenna module, acquire distinguishing identification in the radio frequency signal, and acquire identity identification information in a radio frequency signal the distinguishing identification of which is different from that of other radio frequency signals; and
the antenna module is specifically configured to: send the fourth control signal to the controller, so that the controller controls the RFID label to send the radio frequency signal according to the fourth control signal, the radio frequency signal carrying the identity identification information and the distinguishing identification; and receive the radio frequency signal sent by at least one RFID label, and send the radio frequency signal to the control module.

12. A radio frequency identification (RFID) label, comprising an antenna and an RFID chip connected to the antenna, wherein
the antenna is configured to: receive a control signal, the control signal being used to instruct the radio frequency identification (RFID) label to initiate a capability of sending a radio frequency signal, or being used to instruct the RFID label to send a radio frequency signal that can be identified by a reader; receive a radio frequency signal sent by the RFID chip, and send the radio frequency signal to the reader; and
the RFID chip is configured to: initiate the capability of sending the radio frequency signal according to the control signal, or generate the radio frequency signal that can be identified by the reader, and send the radio frequency signal to the antenna, the radio frequency signal at least carrying identity identification information.

13. The RFID label according to claim 12, wherein,
the antenna is specifically configured to: receive a first control signal, the first control signal being used to instruct the RFID label to initiate the capability of sending the radio frequency signal; and
the RFID chip is specifically configured to: initiate the capability of sending the radio frequency signal according to the first control signal, and send the radio frequency signal to the antenna, the radio frequency signal carrying the identity identification information.

14. The RFID label according to claim 12, wherein,
the antenna is specifically configured to: receive a second control signal, the second control signal being used to instruct the RFID label to send the radio frequency signal that can be identified by the reader; and
the RFID chip is specifically configured to: generate the radio frequency signal according to the second control signal, and send the radio frequency signal to the antenna, the radio frequency signal carrying the identity identification information and distinguishing identification, the distinguishing identification being used to enable the reader to distinguish the received radio frequency signal.
